(19) United States
(12) Patent Application Publication
(10) Pub. No.: US 2006/0277476 A1
(43) Pub. Date: Dec. 7, 2006

(54) Method and system for dynamic generation of graphical content using a markup language

(76) Inventor: Hsuan-Cheng Lai, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/142,348

(22) Filed: Jun. 2, 2005

(51) Int. Cl. G06F 9/00

(52) U.S. Cl. 715/760

(57) ABSTRACT

A method for dynamically generating an HTML-defined chart having node and line elements to be rendered on a display area is disclosed. Node and line element content, relationships between node elements and display settings are received. Node elements are created for the chart using the node content, the node elements having dimensions according to the display settings. A layout for the node elements is defined according to the display settings, the layout including element positioning information for each of the node elements. Line elements are created between the node elements by using the line element content, relationships between node elements and the display settings. HTML code describing the chart is automatically generated using the element positioning, element dimensions and element content.

### FIELD OF THE INVENTION

The invention relates to applications providing a visual representation of relationships between objects. More specifically, it relates to an application that allows dynamic generation of charts representing relationships between objects.

### BACKGROUND OF THE INVENTION

The ability to visualize an organization's structure is key to understanding and making the right business decisions. Typical ways of representing such organizational structure information is through organizational charts. Organizational charts are hierarchical multiple level charts representing entities and the relationships between them. Typical entities illustrated in human resources charts are employees, but similar charts are used to represent relationships between an organization's different business units or product lines.

Traditional org charts have used image-based charts to display organizational structure information. Such org charts were convenient in that the layout of the elements on the page was predefined and did not vary depending on the parameters (such as screen resolution) of the user's display. However, image-based representations of org charts are inconvenient since the time to download is increased due to larger size of image content compared to text content. An additional problem is that such org charts are not easily updateable and new images need to be generated each time there is a change to the organizational structure information.

If such charts have historically been graphic representations of the distribution of authority and responsibility within an organization, advances in technology have allowed for the integration of complex database information into the charts. A newer generation of applications allowing to visualize org chart information has allowed for the dynamic rendering of database-stored information, providing a convenient unified view of multiple business critical details.

Such applications have been web-based and the org charts are displayed into web browsers. A web browser is a software residing on a client computer which allows to display Hypertext Markup Language (HTML) pages received from a server. The HTML page contains instructions for the browser as to how the page contents should be displayed. HTML pages can be static or dynamic. Dynamic pages are those HTML pages generated by the server at each request for information that it receives. The drawback with implementing traditional dynamic HTML pages is that special software is required in order to implement the dynamic functionality. Such special client software usually includes browser plug-ins, JAVA™ applets, Active-X controls and or stand alone applications. The problem with this client-side software is that it requires separate installation and is platform-specific or, in case of JAVA-based applications, that is slow to load and offers decreased performance.

Other methods for dynamically generating graphical content have used markup languages, such as HTML, in order to display charts. Such dynamically generated charts employ the HTML TABLE construct in order to create a table layout structure, including rows and columns defining cells. The cells of such a table are used to hold cell content, such as text and/or images. Using markup languages such as HTML is however inconvenient given the inherent problems associated with HTML-defined positioning. The problem is that the displayed representations of HTML documents are dynamically rendered and unfortunately depend on a plurality of parameters which are user display-specific, and therefore impossible to predict and control. For example, such parameters include: computer system type, dimension of the display window, size and type of display fonts, display size and resolution, etc. When using such tables, misalignment of the chart elements occurs whenever any of the parameters are changed.

The problem of positioning is solved by using image lines for depicting portions of charts. There are however numerous drawbacks associated with this technique, such as the lack of flexibility in positioning elements and the limitations introduced by the HTML layout constructs making it difficult to precisely control the alignment of node elements and image lines. Furthermore, special image lines had to be used to connect each pair of node elements, which required the generation of a new image line whenever any updates or changes were needed.

Additionally, the mark-up language output produced with such prior art techniques cannot be easily interpreted by third party applications such as PDF, MS Word, which is inconvenient for the graphical rendering of an org chart in a different environment.

There exists therefore a need for a system and method allowing the dynamic generation of graphic representation of organizational structure information which avoids the poor performance and lack of flexibility associated with image-based representations. Moreover, there exists a need for a system and method allowing the dynamic generation of graphical content providing the benefits of a markup language definition, but without the dependency on user display parameters.

### SUMMARY OF THE INVENTION

Accordingly, an object of the present invention is to provide a system and method for dynamically generating an HTML-defined chart having node and line elements.

According to a first broad aspect of the present invention, there is provided a method for dynamically generating an HTML-defined chart having node and line elements to be rendered on a display area: receiving node and line element content, relationships between node elements and display settings; creating node elements for the chart using the node content, the node elements having dimensions according to the display settings; defining a layout for the node elements according to the display settings, the layout including element positioning information for each of the node elements; creating line elements between the node elements by using the line element content, relationships between node elements and the display settings; and automatically generating HTML code describing the chart using the element positioning, element dimensions and element content.

### BRIEF DESCRIPTION OF THE DRAWINGS

These and other features, aspects and advantages of the present invention will become better understood with regard to the following description and accompanying drawings wherein:

FIG. 1 is a block diagram of a system for carrying out the method for dynamically generating graphical content in accordance with the present invention;

FIG. 2 is a block diagram of a system for dynamically generating graphical content in accordance with the present invention;

FIG. 3 is a schematical representation of a dynamically generated display including a chart in accordance with the present invention;

FIG. 4 is a flowchart diagram of a method for dynamically generating an HTML-defined chart in accordance with the present invention;

FIG. 5 is a block diagram of a layout for org chart elements according to a preferred embodiment of the present invention;

FIG. 6 is a schematical representation of an org chart using a grid in accordance with the present invention.

FIG. 7 is a schematical representation of org charts according to different display styles, in accordance with the present invention.

### DETAILED DESCRIPTION OF THE PREFERRED EMBODIMENT

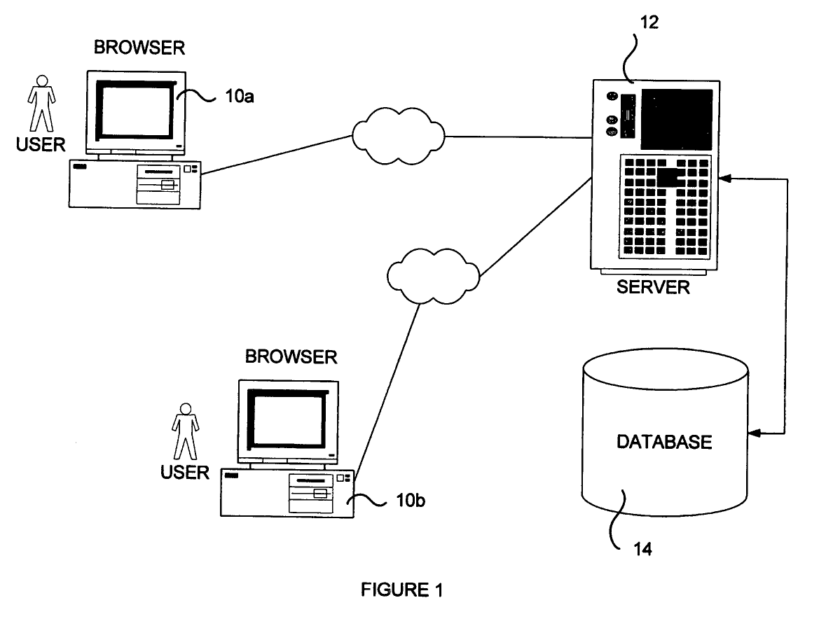

FIG. 1 is intended to provide a general overview description of a suitable computing environment in which the present invention may be implemented. The system of FIG. 1 allows users to use a web-based application to visualize a structure, such as an org chart, which is dynamically generated at every request for information, according to the present invention.

While the detailed description of the preferred embodiment will be made with respect to the dynamic generation of graphical content for an org chart, the system and method of the present invention can be applied to generate graphical content for other types of charts, such as departmental structures, stock inventory, flowcharts, etc.

With respect to FIG. 1, an exemplary system for implementing the invention includes users at user stations 10a, 10b communicating with a server 12 through a network. In one embodiment of the present invention, the network is a public network, such as the Internet, while in other embodiments, the network could be a private network, such as a LAN. The stations 10a, 10b communicate via any suitable transmission media, such as an ordinary public telephone line, a data quality line, a radio link or any other transmission media suitable for data transfer between the components of the system.

The user stations 10a, 10b may be any terminals with web-browsing abilities, such as a personal computer, a web-enhanced cellular phone or a personal digital assistant.

In the preferred embodiment of the present invention the user stations 10a, 10b are computer platforms running, for example, client software or a web-based application and comprise: a computer, an input system including a keyboard and a mouse, a display device, a communication control device for communication with the network and possibly an external storage device. The computer includes a central processor unit (CPU), a read only memory (ROM), a random access memory (RAM) and an internal storage device. The software running at the stations 10a, 10b may reside on an external storage device or an internal one. The storage device may be any one or a combination of, hard disks, optical storage devices, magnetic tape, flash memory, etc.

While in the embodiment shown in FIG. 1 only two user stations 10 are shown, it will be apparent to one skilled in the art that a plurality of user stations 10 could communicate with the server 12 according to the method of the present invention.

Still with respect to FIG. 1, the server 12 receives request for information from users 10a, 10b and accesses the database 14 to retrieve the requested information and to process it such that it is in a format suitable for display. In the preferred embodiment of the present invention, the server 12 is preferably a web server and the information transmitted to the user stations is in a format suitable to be displayed in a web browser. The database 14 stores information regarding employee records and configuration files. In the embodiment illustrated in FIG. 1, the server 12 and the database 14 communicate through a network such as a LAN or a WAN. While the server 12 and the database 14 are illustrated as distinct components in one embodiment, in alternative embodiments they may be part of the same system.

The database 14 may also include one or more processors and memory units, co-operating to retrieve information requested by the server 12 and to perform data updates.

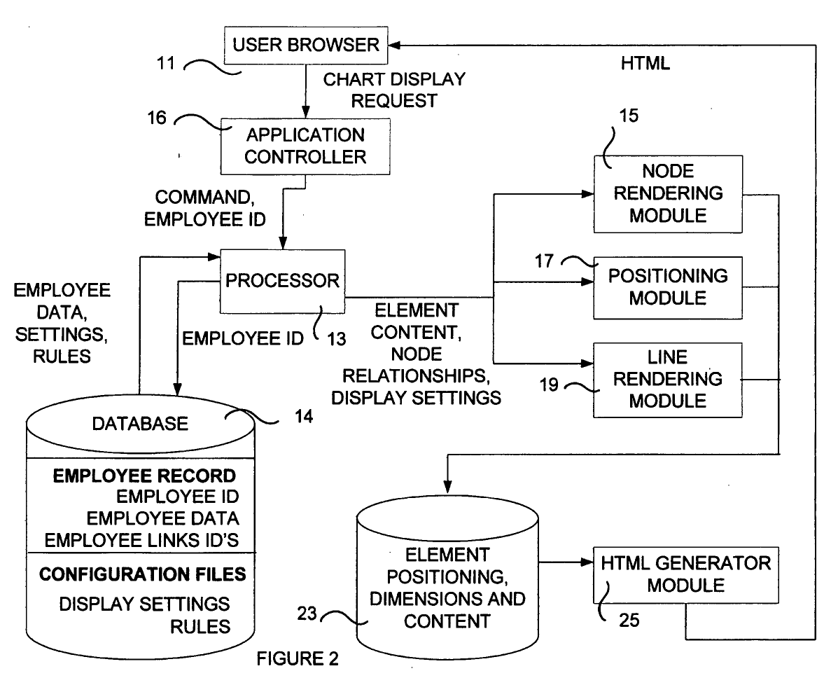

Now, with respect to FIG. 2, the modules of the system of the present invention will be described in more detail. Data used by the server 12 to create the HTML definition of an organizational chart, according to the present invention, is stored in database 14. The data includes, for a current employee, an employee ID, employee data and the employee relationships, namely employee IDs corresponding to other employees with whom the current employee is linked. These will be referred to as “children”, while the current employee will be referred to as “parent”. In a preferred embodiment of the present invention, the database 14 is organized such that the “employee ID” field is a primary key, meaning that it allows to uniquely identify and retrieve information about a particular employee.

Other fields of the employee table of the database 14 store detailed information regarding a particular employee, such as employee name, title, contact information, organizational unit to which the employee belongs, telephone number, fax number, mobile number, location, office number, internal personnel number, hiring date, etc.

Users 11 of the system for displaying dynamically generated charts could be either internal employees or external agents. An access control module (not shown) of the server 12 stores credential information, such as username, password and viewing permissions for each authorized user 11. The viewing permissions for each user 11 include access rights, such that a user 11 may only access information in accordance with these predefined rights.

The data stored in the database 14 could also be stored in Lightweight Directory Access Protocol (LDAP) directories such as Microsoft Active Directory, Netscape Iplanet, in XML files or in Enterprise Resource Planning (ERP) Systems such as SAP, PeopleSoft, etc.

In a preferred embodiment of the present invention, the database 14 also includes configuration files, including display settings and rules. The configuration files contain information that will defined the visual appearance of the org chart elements, the node elements and line elements, as well as their layout on the display screen. The configurations may also be stored as files on the web server, in XML, or other formats.

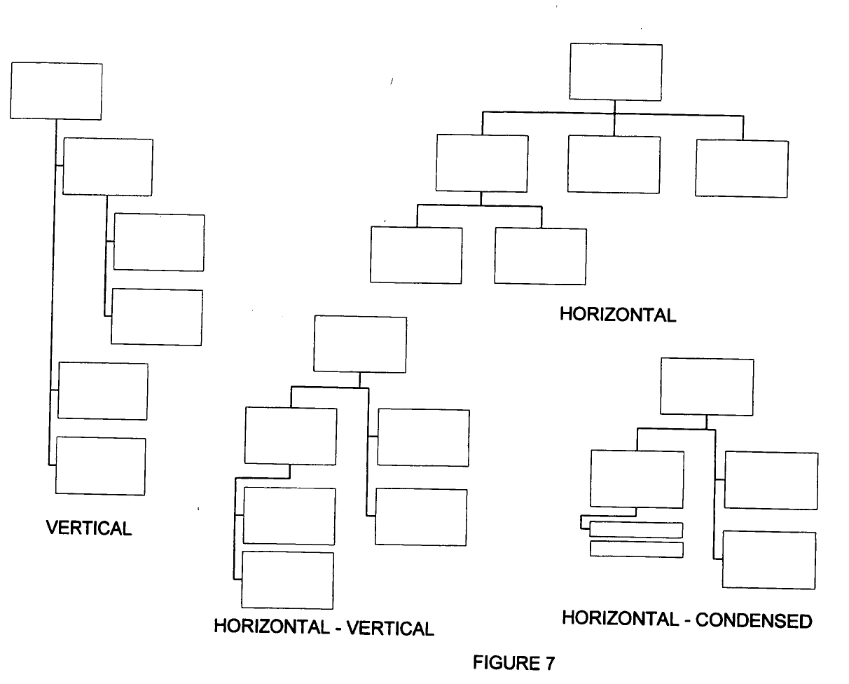

With respect to the layout of the org chart elements on the screen, the configuration files contain information regarding the different styles that may be used to arrange the layout of the org chart element. Different examples of styles are shown in FIG. 7, such as a vertical layout style, a horizontal layout style, a horizontal-vertical layout style and a horizontal-condensed style. Each style is defined using attributes such as: “style”—indicating the layout style of the displayed chart, “condensed”—indicating whether or not the displayed chart is condensed, “lines”—indicating whether lines will be used to connect the nodes, “linestart” and “lineend”—indicating where the lines begins and ends for each node in the org chart rendered In a given style. Other parameters such as “xoffset” and “yoffset” are used to define the horizontal and vertical blank space to be used between different node elements.

The information contained in the configuration files may include for example, the size, shape and color of a node element, as well as the font type and font size to be used for its content, and regarding the node element content, fields to be included from the employee record. Regarding the line elements, the configuration files may include information about the line style, width, color, etc.

In a preferred embodiment of the present invention, the rules defining the visual appearance of the chart elements are provided using a Cascading Style Sheets (CSS) definition. As it is well-known to those skilled in the art, CSS styles allow to define properties relating to color, fonts, text, boxes, positioning and classification of elements in a versatile manner.

For example, a CSS-definition of the color for a node element according to the present invention is shown below:

```
.NodeElementColor
{
  BACKGROUND-COLOR: #cedefa;
  FILTER:progid:DXImageTransfom.Microsoft.Gradient(gradientType=0,
startColorStr=#cedefa,endColorStr=#ffffff);
  BORDER-COLOR: #000000;
  BORDER-WIDTH: 1 1 1 1;
  BORDER-STYLE: solid;
}
```

For exemplary purposes, the CSS definition for a line element according to the present invention is shown below:

```
.OrgchartLine_Vertical
{
  BORDER-WIDTH: 0 1 0 0;
  BORDER-STYLE: solid;
  BORDER-COLOR: black;
}
```

The CSS definition is applied to HTML constructs that define the shape and layout of the line.

Referring back to FIG. 2, the server 12 includes an application controller 16, a processor module 13, a node rendering module 15, a positioning module 17, a line rendering module 19 and an HTML-generator module 25.

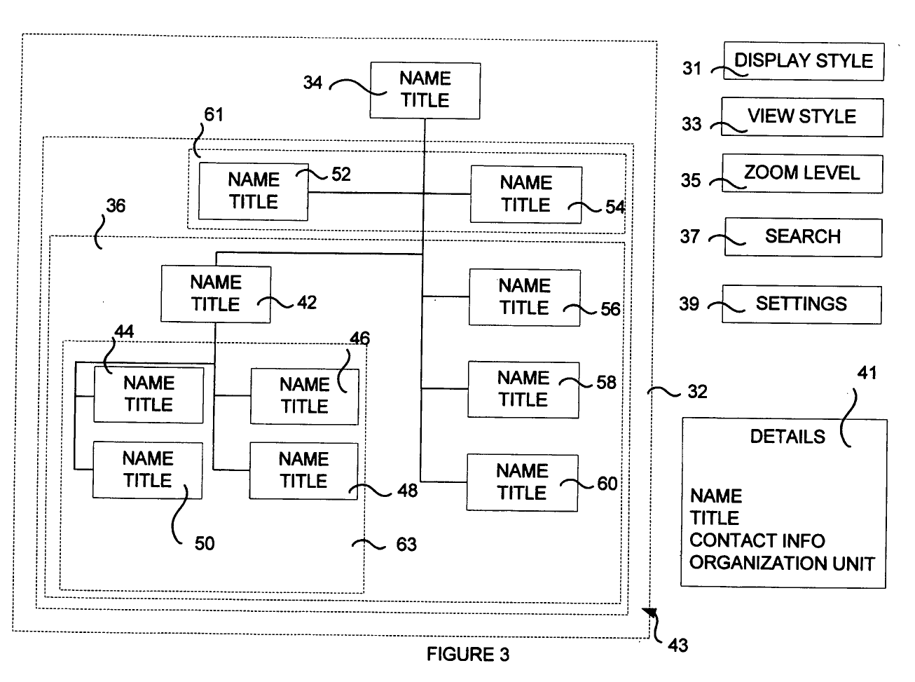

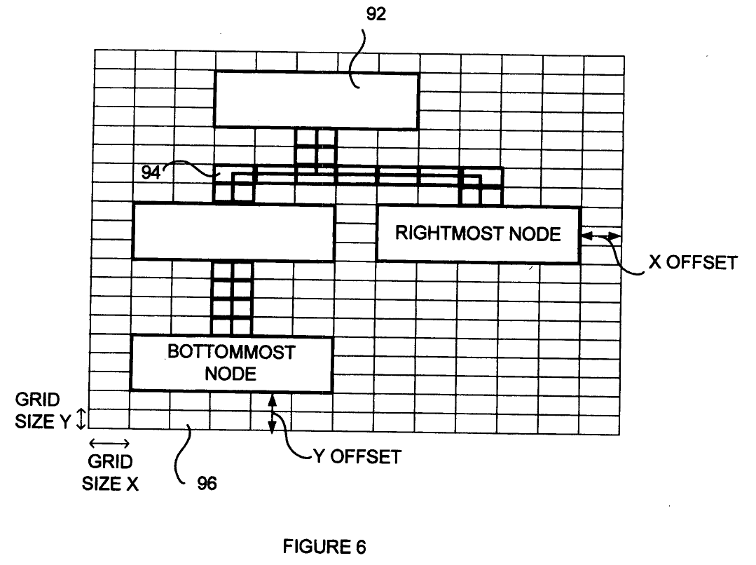

Now, with respect to FIG. 3 and FIG. 6, which contain schematical org charts according to the present invention, an exemplary org chart 43 will be described. The org chart 43 has node elements 92, representing the employees of the organization and line elements 94, representing the relationships between the employees.

With respect to FIG. 3, a plurality of node elements are shown, such as 34, 42, 44, 46, 48, 50, 52, 54, 56, 58 and 60. The web application provides a user 10 with the possibility of obtaining more information about a particular employee by interacting with the node element corresponding to that employee, such as by selecting and/or clicking the node element. Additional information regarding a particular employee may be viewed in a details 41 section of the display.

The web application interface also includes a plurality of buttons, such as display style 31, view style 33, zoom level 35, search 37 and settings 39. The display style button 31 is used to send a display style request to the server with the style chosen. The org chart is re-rendered according to the style specified. The view style button 33 is used to send a view request to the server 12 with the view style chosen. The org chart is re-rendered according to the style specified. The zoom level 35 controls the zoom level on the client browser, by using Javascript to change the zoom level using CSS. The search 37 and settings 39 buttons open panels in the browser to display controls for searching and for setting preferences for the chart.

Actions may be defined which are performed in response to a user clicking on a node element or on a selected area of a node element.

For example, upon the user clicking a node element in an area associated with expanding the node, a request is sent back to the server 12 with the ID of the node element the user clicked on. The server 12, upon receiving the expand command, fetches the “children” IDs of that node element, and creates node elements for each one of the “children”, in order to rerender the org chart. With respect to FIG. 3, in the case in which nodes 44, 46, 48 and 50 were not shown, by clicking on node 42, a command would be sent to the server 12 to fetch the ID's of the node elements to be displayed, then these additional nodes will be displayed to the user.

As another example, a “close” request is sent back to the server 12 with the ID of the node element the user clicked on. The server 12 then retrieves the IDs of all node elements that are directly or indirectly “children” of the selected node element, removes them from the HTML definition of the org chart and then re-renders the org chart.

Yet as another example of request, a “root” request can be sent back to the server 12 with the ID of the node element the user clicked on. The server 12 then retrieves the IDs of all node elements that are directly or indirectly “children” of the selected node element, and removes all other node elements from the HTML definition of the org chart and then re-renders the org chart.

Similarly, an “up-level” request sends back to the server 12 the ID of the node element the user clicked on. The server 12 fetches the IDs and information about the parent and peers of the selected node element, creates corresponding node elements and adds this information to the HTML definition of the org chart and the org chart is then re-rendered.

Now, referring back to FIG. 2, the interaction between the modules of the present invention will be described.

A user browser 11, such as Microsoft Internet Explorer™ or Netscape Navigator™, sends a request for an org chart to be displayed. The request is in the form of a request for a Uniform Resource Locator (URL) address. The request is received by the application controller module 12 and is processed to extract the type of request and its parameters. The type of requests specifies the page that is to be returned to the client browser. The parameters sent with each request include: the action to be performed, the ID of the selected node element, the settings selected (such as display style, view style, etc., as well as the user's id, which allows to identify his session state from that of any other user accessing the same org chart information.

In an exemplary request, the browser 11 sends an “expand” command and the corresponding “employee ID” parameter in order to view employees for which node elements are not displayed. The command and the parameter are extracted from the request by the application controller 12 and forwarded to the processor module 13.

The processor 13 uses the “employee ID” parameter to query the database 14 and to extract the corresponding employee record information, such as employee details and employee relationships and the records for each “employee ID” that the current employee is linked to. At the same time, the processor 13 retrieves the display settings and rules defining how to generate the HTML for the expanded section.

The processor 13 then provides the layout settings and the node data retrieved from the database 14 to a node rendering module 15. The node rendering module will assemble, for each employee ID, the information retrieved from the employee record and create a new node element for the org chart. The shape and size, as well as other attributes of the node elements, are as defined by the settings parameters.

In one embodiment of the present invention, the information retrieved for each node element is provided in XML format. An Extensible Sytlesheeet Language (XSL) stylesheet is used as an HTML template in order to generate the HTML output describing the org chart, by linking the XML document to the XSL stylesheet.

Alternatively, it is possible to write code to directly generate HTML output based on the parameters and information provided. An example of this is shown below:

String field_value; // value of the field such as last name, first name
String a;
a = “<TABLE><TR><TD>” + field_value + “</TD></TR></TABLE>”
return a;

Once all new node elements to be added to the org chart are generated, a positioning module 17 will determine and define the layout for the node elements of the org chart. The positioning module 17 uses either a single or a mufti-reference coordinate system. The coordinate system is preferably a 2-dimensional coordinate system, such as the (x,y) coordinate system. The node elements to be displayed are objects having properties such as location, size, etc.

The layout of the node elements may be in terms of absolute or relative positioning. If absolute positioning is used, the (x,y) coordinates of the node element are defined in terms of absolute values. If relative positioning is used, the (x,y) coordinates of the node element are defined with respect to a reference node element.

With respect to FIG. 3, the method for defining the layout of the node elements in terms of relative positioning will be described. The set of node elements of an org chart 43 are separated into multiple groups, such as group 36, including sub-group 63 and group 61.

As another example, in group 32, node element 34 is a parent node, while node elements 52, 54, 56, 58, 60 and 42 are children node elements. However, these node elements are grouped together into 2 sub groups 61, 36. When laying out group 32, the algorithm only has to be concerned about laying out node 34, and 2 virtual nodes 61, 36. If a child node, such as node element 42 also has children, the children of node 42 are represented in group 36 by a virtual node whose size depends on the layout of the group 63. Group 63 will therefore be referred to as a sub-group with respect to group 36.

The layout of the node elements is defined as follows. Each group maintains its own coordinate system. Nodes in the group are laid out with respect to the group coordinate system. Groups are processed from the bottom up, so all groups with no sub groups are processed, then groups that contain sub groups that have been processed and so on and so forth. The processing for each group lays out the nodes within the group, using information about the nodes. For example, information about the width and height of node 50, as well as information about the xoffset and yoffset space surrounding node 50 (defined in the display settings) will be used to calculate the positioning of the other nodes of the same subgroup 63. When all node elements of subgroup 63 have been positioned, the size of the sub-group is calculated. The size of subgroup 63 will then be used for calculating the position of node element 42 (parent node element) and node elements 56, 58 and 60 of sub-group 36. The process is repeated recursively until all node elements have positioning information defined.

After all positioning information is defined, the absolute position of each node with respect to the outermost group is computed by adding together the (x,y) coordinates of a node element, to the (x,y) coordinates for each virtual node that represents the group the node belongs to. Hence, to compute the absolute (x,y) coordinates of node 50, the computation would be as follows:
abs node 50 x=Node 50 x+Group 63 x+Group 36 x+Group 43 x.

Similarly,
abs node 50 y=Node 50 y+Group 63 y+Group 36 y+Group 43 y.

Depending on the style selected (either by default or by selecting a display style option), the node elements are laid out directly under the current group of nodes being processed. As it has been described above, and with respect to FIG. 7, available display styles include: vertical display—all the node elements are laid out vertically, with indentations to indicate parent-child relationships; horizontal display—each set of children node elements occupy a single row under their parent node element; horizontal-vertical display—each set of children node elements are laid out in multiple rows under their parent node element, while any children node elements that in turn have children node elements are laid out horizontally in a single row; horizontal—condensed display—each set of children node elements is laid out in a single column if those children do not have other children. If they do, the children are laid out in the horizontal-vertical style.

Still with respect to FIG. 2, the line rendering module 21 determines, for each node element, given the node elements dimensions and position, the set of line elements necessary to connect the node elements. Depending on the size of a line element and on the distance between a pair of node elements to be connected, a plurality of line elements, of different types, may be used in order to connect the node elements.

For a given node element, the line rendering module 21 receives the node relationships, meaning the IDs of all other node elements that are connected to it, in order to determine which pairs of node elements need to be connected and creates line elements for them. The properties of each line element can be defined, in a preferred embodiment of the present invention, as CSS definitions, such as in the exemplary definition provided below:

```
HTML:
<TABLE height=”5” width=”2” class=”OrgchartLine_Vertical”>
<TR><TD></TD></TR></TABLE>
CSS:
. OrgchartLine_Vertical
{
  BORDER-WIDTH: 0 1 0 0 ;
  BORDER-STYLE: solid;
  BORDER-COLOR: black;
}
```

Alternatively, the line elements can be defined using line images stored on the server 12, by providing the link to a line image, such as:

HTML:
<IMG SRC=”Images/Lines/line.gif”>

Alternatively, the line elements can be defined using line images and CSS such as

```
HTML:
<div class=”OrgchartLine_Vertical”></div>
CSS:
. OrgchartLine_Vertical
{
  Height: 5px;
  Width: 5px;
  Background-Image: Images/Lines/line.gif;
}
```

Depending on the dimensions (height and width) and content of the line images used, a plurality of line images may be needed in order to connect a pair of node elements.

The line rendering module 21 connects the node elements together using the node positioning information, and also the style settings such as the linestart, lineend settings that define where the line starts and ends. Lines are created by examining each node element and its parent, and generating straight line segment information. After all line segments are generated, the rendering module 21 breaks the line segments down into line elements which are of a fixed size of either a vertical or a horizontal orientation. Where two or more line segments meet, these are converted into corner or junction line segments, for example, such line element 94 in FIG. 6.

For all node and line elements, the element positioning information, the element dimension information, as well as the element content information are recorded in a storage structure 23.

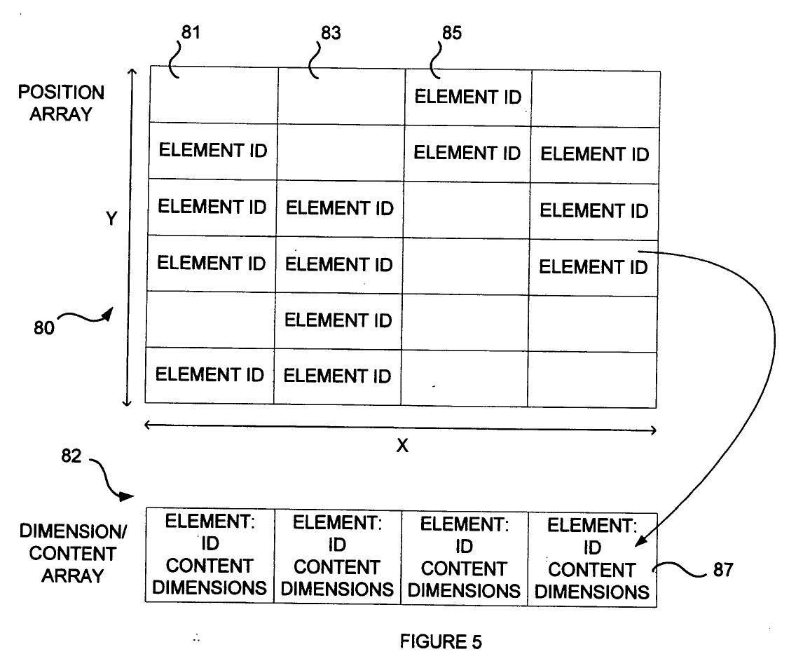

With respect to FIG. 5, in a preferred embodiment of the present invention, the storage structure 23 is implemented as a set of arrays, including a 2-dimensional array 80 containing the element positioning information of the org chart elements, as well as a 1-dimensional array 82 storing element dimension information and element content information. The information between the two arrays 80, 82 is linked through element IDs, as will be explained in more detail below.

With respect to FIG. 6, the display area of the screen on which the org chart is to be displayed is defined as a 2-dimensional grid. The grid has rows and columns, defining grid cells 96, having a width and a height. This grid represents the display area upon which the org chart is draw. In FIG. 5, the 2-dimensional array 80 is a representation of the display area allowing to position elements of the org chart, by storing in the appropriate grid cell, the ID of the element occupying the location on the area. The positioning in the array 80 is based on the element positioning defined previously as the layout of the node elements was defined.

In a preferred embodiment of the present invention, X, the number of elements in a row of the position array 80, is calculated according to the formula:
# of elements/row:(MAX x-coordinate of org chart)/x-length of grid cell

in which “MAX x-coordinate of org chart” represents the maximum x-coordinate that an element of the org chart will be positioned at and the x-length of a grid cell represents the width of a grid cell. The MAX x-coordinate of the org chart is calculated after the layout of all node elements has been determined, i.e. positioning information exists for all node elements. As shown in FIG. 6, the MAX x-coordinate is calculated by adding the x-coordinate of the rightmost node element of the org chart to the width of the node element and to any “xoffset” space following the node element.

Similarly, the number of elements in a column of the position array 80 is calculated according to the formula:
# of elements/column:(MAX y-coordinate of org chart)/y-length of grid cell
in which “MAX y-coordinate of org chart” represents the maximum y-coordinate that an element of the org chart will be positioned at and the y-length of a grid cell 96 represents the height of a grid cell 96. The MAX y-coordinate of the org chart is calculated after the layout of all node elements has been determined, i.e. positioning information exists for all node elements. As shown in FIG. 6, the MAX y-coordinate is calculated by adding to the y-coordinate of the bottommost node element, the height of each node element, to the “yoffset” space following the node element.

The grid cell dimensions, x-length (width) and y-length (height), are chosen/defined according to different requirements. The x, y lengths of the nodes are chosen based on the amount of content placed in each node to ensure that the org chart is aesthetically pleasing. The grid cell dimensions are chosen based on the amount of bandwidth that the org chart will use, and also based on how aesthetically pleasing the org chart should be. A smaller grid resolution results in more HTML code needing to be transferred to describe the same sized org chart, but provides better resolution for the line elements, so that elements may be more easily positioned. Typically, a grid size of 5, 10, or 20 pixels are sufficient to meet these criteria.

Some of the cells of the 2-dimensional position array 80, such as cell 85, hold an ID corresponding to an element (node or line) for which the dimension information and the content information are stored in the dimension/content array 82. Other cells of the position array 80, such as cells 81 and 83, are empty, meaning that no elements are to be displayed in the space they represent.

The size of the dimension/content array 82, i.e. the total number of elements stored in the array, is given by the total number of node elements of the org chart plus the total number of types of line elements. For each cell 87 of the dimension/content array 82, there is stored an ID identifying the element stored, the element content information and the element dimension information. The element content information includes the HTML content representing the element, while the element dimension information includes the height and the width of the element, expressed in terms of number of grid cells.

While in the preferred embodiment of the present invention, the element positioning is stored as a position array 80 and information regarding the element dimensions and content is stored in a dimension/content array 82, in other embodiments, a single array could be used to store all the element information.

In a preferred embodiment of the present invention, the 2-dimensional array 80 and the 1-dimensional array 82 are read by the HTML generator module 25 in order to generate the HTML defining the org chart to be displayed. In a first step, the outer table tags “<TABLE>” are generated, defining the layout structure which will hold the org chart. At the beginning of each row, the table row tag “<TR>” will be generated. Then, starting from the first row, first column, each cell of the two-dimensional array is processed in order.

When examining a cell, if the cell is not empty, that is, if it stores an element ID, the HTML generator 25 generates the cell tags “<TD></TD>” and adds to them the contents of the 1-dimensional array corresponding to the element ID. If the dimension information, i.e. the height and width, of the element are such that the element occupies multiple cells, the HTML generator 25 adds attributes to the “<TD>” tag to specify the height and width using ‘colspan’ and ‘rowspan’.

If a cell is empty, the HTML generator 25 generates an empty cell, that is the cell tags “<TD></TD>” without any content.

At the end of each row of the position array 80, the HTML generator 25 generates an end-of-row tag “</TR>”. When the whole position array 80 has been processed, the HTML generator 25 generates the end-of-table tag “</TABLE>”.

When processing empty cells, such as cells 81, 83, a simple approach to reducing the size of the generated HTML code is to continue traversing the row, keeping track of the total number of consecutive empty cells. When a non-empty cell is found, the HTML generator 25 generates a tag such as: “<TD colspan=“x”></TD>” where x is the number of consecutive empty cells. In the case shown in FIG. 5, in row 1, the total number of consecutive empty cells is 2. Still with respect to FIG. 5, The HTML generator 25 would therefore create a “<TD colspan=“2”></TD>” construct to represent the two empty adjacent cells.

Similarly, the HTML code can further be improved by checking for empty cells along the columns of the 2-dimensional array. In this case, empty cells must then be flagged by putting a special value into them, in order to indicate that they have been processed.

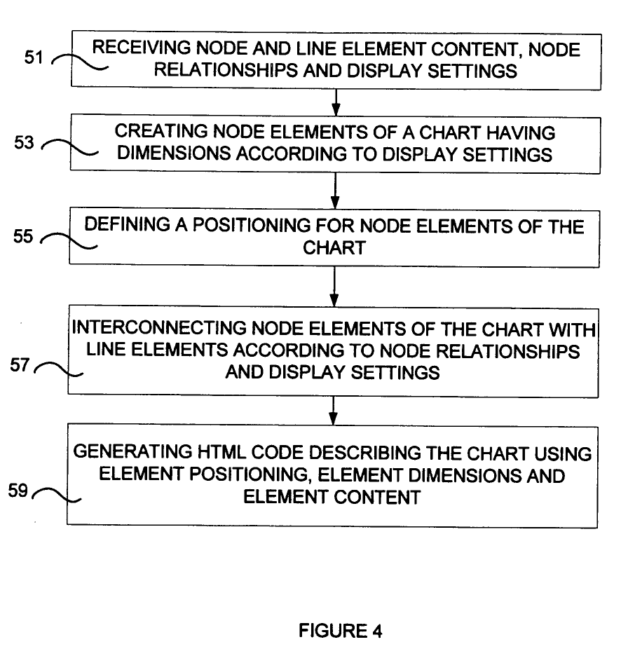

With respect to FIG. 4, a method for dynamically generating an HTML-defined chart having node and line elements will be described. In a first step 51, node and line element content, as well as node relationships and display settings are received. In a next step 53, the node elements of the chart are created, the node elements having dimensions according to the display settings. In step 55, a positioning for the node elements of the chart is defined and in step 57, the node elements of the chart are interconnected with line elements according to the node relationships and the display settings. Finally, in step 59, HTML code describing the chart is generated using element positioning, element dimensions and element content.

It will be understood that numerous modifications thereto will appear to those skilled in the art. Accordingly, the above description and accompanying drawings should be taken as illustrative of the Invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for dynamically generating an HTML-defined chart having node and line elements to be rendered on a display area:
receiving node and line element content, relationships between node elements and display settings;
creating node elements for said chart using said node content, said node elements having dimensions according to said display settings;
defining a layout for said node elements according to said display settings, said layout including element positioning information for each of said node elements;
creating line elements between said node elements by using said line element content, relationships between node elements and said display settings;
automatically generating HTML code describing said chart using said element positioning, element dimensions and element content.

2. A method as claimed in claim 1, wherein said chart is an org chart and wherein said node elements represent members of an organization and said node content is information regarding said members.

3. A method as claimed in claim 1, wherein said line elements are represented using at least one line image.

4. A method as claimed in claim 1, wherein said line elements are represented using a CSS definition.

5. A method as claimed in claim 1, further comprising:
defining said display area as a 2-dimensional grid, having rows and columns defining grid cells, having grid cell dimensions;
creating a 2-dimensional array representing said display area, storing for at least some of said grid cells, an element having element dimensions and element content, and wherein an element is placed in a grid cell based on said element positioning and said grid cell dimensions;
and wherein said automatically generating HTML code includes reading element information from said array and generating HTML code.

6. A method as claimed in claim 5, wherein said defining a layout for said nodes including element positioning includes:
grouping said node elements according to node relationships, such that children node elements of a same parent node element are part of a group;
defining relative positioning for each of said children node elements of said group with respect to a coordinate system of said group;
defining a virtual node element having dimensions of said group and defining a positioning therefor;
for each of said children node elements, computing absolute positioning by adding said relative positioning to said positioning of said virtual node element.

7. A method as claimed in claim 1, further comprising:
rendering said HTML code to display said chart on said display area.
